(19) United States
(12) Patent Application Publication
(10) Pub. No.: US 2007/0111919 A1
(43) Pub. Date: May 17, 2007

(54) Detergent granules and process for their manufacture

(76) Inventors: Renee Boerefijn, Vlaardingen (NL); Pieter Goedendorp, Kc Maassluis (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/583,678

(22) PCT Filed: Nov. 19, 2004
(86) PCT No.: PCT/EP04/13249

§ 371 Date: Jun. 19, 2006

(30) Foreign Application Priority Data
Jun. 24, 2004 (EP) 04076847.5
Dec. 19, 2003 (EP) 03079123.0

(51) Int. Cl. C11D 17/00

(52) U.S. Cl. 510/445

(57) ABSTRACT

A granulate detergent product comprising coated granules which comprise a functional core which comprises one or more detersive agents selected from surfactants and detergency builders, the coated granules further comprising up to 10% by weight of a coating which comprises encapsulated perfume.

### TECHNICAL FIELD

The present invention relates to granulated detergent compositions comprising an encapsulated perfume.

### BACKGROUND OF THE INVENTION

It is known to incorporate perfumes into granulated detergent compositions, in the form of so-called “microcapsules”. One known form of microcapsule consists of melamine-urea-formaldehyde microcapsules having a perfume core. Modern high bulk density detergent granules are conventionally prepared by mechanical mixing and densification of the surfactant and other components (usually including detergency builder) either to form the final product or to prepare a pre-granulated concentrated adjunct to which one or more other ingredients may be post-dosed. However, to incorporate perfume microcapsules into the material being agglomerated in this way has been found to result in various negatives, such as poor dispersibility, with subsequent mechanical loss, undesirable residues and product inefficacy (from the point of view of delivery of the perfume).

Dry addition of the microcapsules tends to result in loose agglomerates of the capsules which are then difficult to disperse throughout the composition without use of significant shear forces, resulting in subsequent noticeable perfume loss.

Another alternative route of dropping the microcapsules onto the rest of the composition on a conveyer also tends to result in undesirable cluster formation.

This problem has now been solved by incorporating the encapsulated perfume in a slurry and spraying the slurry onto a powdered (preferably pre-granulated) composition which comprises one or more conventional ingredients of detergent compositions. This results in so-called “layered” detergent granules which comprise a functional core of the conventional detergent ingredient(s) and an outer layer comprising the encapsulated perfume.

The so-called “layering” of detergent granules is well-known in the art, usually in the context of adding a “layering agent” (usually, an aluminosilicate) in the final stage of non-spray drying mechanical granulating process for detergents, for example as described in “Surfactants in Consumer Products”, Springer Verlag, 1987, pp 411-413. This is usually done to improve the flow properties of the product and/or to control granule size distribution during the agglomeration process.

### DEFINITION OF THE INVENTION

A first aspect of the present invention provides a granulate detergent product comprising coated granules which comprise a functional core which comprises one or more detersive agents selected from surfactants and detergency builders, the coated granules further comprising up to 10% by weight of a coating which comprises encapsulated perfume.

A second aspect of the present invention provides a granulate detergent product in which at least 10% of the total number of granules are coated granules which comprise a functional core which comprises one or more detersive agents selected from surfactants and detergency builders, the coating comprising encapsulated perfume.

A third aspect of the present invention provides a process for making a granulate detergent product, the process comprising:
(i) providing a powdered and/or granulated detersive composition comprising one or more detersive agents selected from surfactants and/or detergency builders;
(ii) preparing a slurry comprising water and an encapsulated perfume;
(iii) spraying the detersive composition with said slurry to form coated granules.

The resultant product of this process may, for example, fulfil the requirements of the first and/or second aspect of the present invention.

To avoid any confusion it is noted that the term granulate detergent product encompasses detergent products for cleaning and/or conditioning of laundry. Accordingly, the term detersive agents as used in all aspects of the invention also encompasses softening materials. Thus, for all aspects of the invention the detersive agent may be selected from surfactants, softening materials and/or detergency builders.

### DETAILED DESCRIPTION OF THE INVENTION

To avoid any doubt, the term “granulate” for the purpose of the present invention means a granule comprising a plurality of ingredients, for example having a porous complex microcrystalline structure as can be formed by spray-drying or an agglomerate of individual particles (crystalline or amorphous) which can be formed by spray-drying or by mechanical granulation (typically mixing/densification).

In the process of the present invention, the slurry is applied in an amount such that the coating on the granules constitutes up to 10% by weight of those granules. However, preferably, the coated particles constitute up to 5%, more preferably up to 3%, 2.5% or 2%, still more preferably up to 1% by weight or even up to 0.75% or 0.5% by weight of the coating.

In the case of the second aspect of the invention, the coated granules constitute at least 10% but preferably at least 15%, 20%, 25%, 30%, 35%, 40%, 45% or 50%, eg at least 80% or 90% of the number of granules.

It is also preferred to incorporate some non-encapsulated perfume in the slurry, preferably in an amount of from 0.0001% to 50%, more preferably from 25% to 50% by weight of the slurry, or preferably in a weight ratio of unencapsulated perfume to the perfume capsules of from 1:10 to 1:1, more preferably from 1:2 to 1:1.

Other ways of incorporating unencapsulated perfume are to blend the coated granules with perfume or to spray it on to those finished granules, before or simultaneously with application of the slurry.

Preferably also, a viscosity modifier in the form of a lubricant such as glycerol is included in the slurry to facilitate pumping and atomisation.

Preferably, the d_{3,2} average particle diameter of the coated detergent granules is from 100 μm to 2000 μm, preferably 180 μm to 1,400 μm, more preferably from 500 μm to 710 μm.

The Encapsulated Perfume

A number of different encapsulated perfumes suitable for use in detergent compositions are commercially available. A preferred kind of such capsule is in the form of melamine-urea-formaldehyde microcapsules, available from 3M Corporation or BASF.

The encapsulated perfume is preferably dispersed in the slurry (which comprises water) in an amount of from 5% to 80%, more preferably from 40% to 80% by weight of the slurry.

The Granulation Apparatus

A process according to the second aspect of the present invention may be carried out in either batch or continuous mode of operation as desired.

The process of the invention is preferably carried out in a mechanical granulator, most preferably a low- or moderate shear machine. A low- or moderate-shear mixer/granulator often has a stirring action and/or a cutting action which are operated independently of one another. Preferred types of low- or moderate-shear mixer granulators are mixers of the Fukae^{R} FS-G series; Diosna^{R} V series ex Dierks & Sohne, Germany; Pharma Matrix^{R} ex. T. K. Fielder Ltd, England. Other mixers which are suitable for use in the process of the invention are Fuji^{R} VG-C series ex Fuji Sangyo Co., Japan; the Roto^{R} ex Zanchetta & Co. sri, Italy and Schugi^{R} Flexomix granulator.

Another possible low shear granulator is one of the gas fluidisation type, which comprises a fluidisation zone in which the liquid binder is sprayed into or onto the solid neutralising agent. However, a low shear bowl mixer/granulator can also be used. When the low shear granulator is of the gas fluidisation kind it may sometimes be preferable to use equipment of the kind provided with a vibrating bed. This may be preferable if the perfume loading of the slurry is to be low and when drying is required. Gentle heating of the fluidisation air is preferred to avoid premature perfume release.

If the low-shear granulator is of the gas fluidisation kind, then the liquid binder can be sprayed from above and/or below and/or within the midst of the fluidised material.

If a gas fluidisation granulator is used as the low-shear granulator, then preferably it is operated at a superficial air velocity of about 0.1-2.0 ms⁻¹, either under positive or negative relative pressure and with an air inlet temperature ranging from −10° or 5° C. up to 80° C., or in some cases, up to 200° C. An operational temperature inside the bed of from ambient temperature to 60° C. is typical. Depending on the process, it may be advantageous to vary the temperature (upwardly and/or downwards, during at least part of the process).

Compositional Features

The core of the granulate granules made by a process according to the present invention contains at least one surfactant, softening material and/or detergency builder. Any such ingredient may also additionally be incorporated in the coating, via the slurry.

In addition, any granulate according to the present invention may be incorporated in a detergent composition such as a particulate detergent composition comprising one or more post dosed materials. Optionally, any granulate or particulate detergent composition according to any aspect of the present invention may be compressed into tablet form by known technique, e.g. such as a tablet also comprising a disintegrant. Such a tablet constitutes a further aspect of the invention. Suitable tablet formats/processing are for example disclosed in: EP 1,371,729, EP 1,405,900, EP 1,382,368, EP 1,375,636, EP 1,405,901, EP 1,405,902, EP 1,418,224 and WO 03/104380

To avoid any confusion it is noted that the term particulate detergent composition encompasses particulate detergent compositions for cleaning and/or conditioning of laundry. Accordingly, the particulate detergent compositions may include surfactants, builders, softening materials other ingredients as described below

Surfactants

Suitable surfactants are selected from one or more of anionic, non-ionic, cationic, zwitterionic and ampholeric surfactants. In general, suitable surfactants include those generally described in “Surface active agents and detergents” Vol. I by Schwartz and Perry. If desired, soap derived from saturated or unsaturated fatty acids having, for example, C₁₀ to C₁₈ carbon atoms may also be present.

Anionic surfactant may actually comprise one or more different anionic surfactant compounds. Preferred anionic surfactants are alkylbenzene sulphonates, particularly so-called linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %.

The granulates of the invention may additionally or alternatively contain other anionic surfactants in amounts additional to the percentages quoted above. Suitable anionic surfactants are well-known to those skilled in the art. Examples include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

The granulates of the invention may also contain non-ionic surfactant. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

It is preferred if present the level of non-ionic surfactant is from 0 wt % to 30 wt %, preferably from 1 wt % to 25 wt %, most preferably from 2 wt % to 15 wt %.

Detergency Builders

Detergency builders may generally be incorporated in amounts of from 10 to 70% by weight (anhydrous basis), preferably from 25 to 50 wt %. Preferred detergency builders are alkali metal, preferably sodium, aluminosilicate builder.

The alkali metal aluminosilicate may be either crystalline or amorphous or mixtures thereof, having the general formula: 0.8-1.5 Na₂O. Al₂O₃. 0.8-6 SiO₂

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium alumino silicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Softening Materials

The detersive agent may also comprise softening materials. The term softening material is used herein for purposes of convenience to refer to materials which provide softening and/or conditioning benefits to fabrics in the wash cycle of a home or automatic laundering machine or in a manual wash process.

When the particulate detergent compositions according to the invention comprise softening material, the compositions preferably comprise from 10 to 95% by weight of softening material (active ingredient), based on the total weight of the composition, more preferably 15 to 75% by weight, most preferably 20 to 50% by weight, e.g. 22 to 45% by weight.

The softening material comprises preferably at least one cationic softening material such as quaternary ammonium fabric softening material. Preferably the quaternary ammonium fabric softening material has two C12-28 alkyl or alkenyl groups connected to the nitrogen head group, preferably via at least one ester link. It is more preferred if the quaternary ammonium material has two ester links present.

Preferably, the average chain length of the alkyl or alkenyl group is at least C14, more preferably at least C16. Most preferably at least half of the chains have a length of C18.

It is generally preferred that the alkyl or alkenyl chains are predominantly linear.

Especially preferred materials are di-alkenyl esters of triethanol ammonium methyl sulphate and N-N-di(tallowoyloxy ethyl) N,N-dimethyl ammonium chloride. Commercial examples include Tetranyl AHT-1 (di-hardened oleic ester of triethanol ammonium methyl sulphate 80% active), AT-1 (di-oleic ester of triethanol ammonium methyl sulphate 90% active), L5/90 (palm ester of triethanol ammonium methyl sulphate 90% active), all ex Kao™. Other unsaturated quaternary ammonium materials include Rewoquat™ WE15 (C10-C20 and C16-C18 unsaturated fatty acid reaction products with triethanolamine dimethyl sulphate quaternised 90% active), ex Witco™ Corporation.

Other preferred materials include 1,2 bis[tallowoyloxy]-3-trimethylammonium propane chloride and 1,2-bis[oleyloxy]-3-trimethylammonium propane chloride, the method of preparation thereof are, for example, described in U.S. Pat. No. 4,137,180 (Lever Brothers) of which the contents are incorporated herein. Preferably these materials also comprise small amounts of the corresponding monoester, as described in U.S. Pat. No. 4,137,180.

When the detergent composition is to be used as a solid rinse conditioner, the composition may be as described in WO03/083027. Other examples of suitable solid rinse conditioners are described in EP-A-0 234 082, EP-A-0 111 074, EP-A-0 111 074, WO 92/18593, EP-B1-0 568 297, US-A-5 259 964, EP-A-0 107 479 (Unilever), EP-A-0 267 999 (Unilever), JP-A-06 306 769, JP-A-62 057 639 (Lion), JP-A-02 182 972, U.S. Pat. No. 4,814,095, GB-A-2 348 435.

Another class of softening materials are fabric softening clays. In particular those that cooperate with the organic fatty softener materials to provide enhanced softening of laundry. Such clays include the montmorillonite-containing clays which have swelling properties (in water) and which are of smectite structure. The best of the smectite clays for use in the present invention is bentonite and the best of the bentonites are those which have a substantial swelling capability in water, such as the sodium and potassium bentonites. Such swelling bentonites are also known as western or Wyoming bentonites, which are essentially sodium bentonite. Other bentonites, such as calcium bentonite, are normally non-swelling and usually are, in themselves, unacceptable as fabric softening agents.

However, it has been found that such non-swelling bentonites exhibit even better fabric softening in combination with organic fatty softener materials than do the swelling bentonites, provided that there is present in the softening composition, a source of alkali metal or other solubilising ion, such as sodium (which may come from sodium hydroxide, added to the composition, or from sodium salts, such as builders and fillers, which may be functional components of the composition). Among the preferred bentonites are those of sodium and potassium, which are normally swelling, and calcium and magnesium, which are normally non-swelling. Of these it is preferred to utilise calcium (with a source of sodium being present) and sodium bentonites. The bentonites employed may be produced in the United States of America, such as Wyoming bentonite, but also may be obtained from Europe, including Italy and Spain, as calcium bentonite, which may be converted to sodium bentonite by treatment with sodium carbonate, or may be employed as calcium bentonite. Also, other montmorillonite-containing smectite clays of properties like those of the bentonites described may be substituted in whole or in part for the bentonites described herein and similar fabric softening results will be obtained.

The swellable bentonites and similarly operative clays are of ultimate particle sizes in the micron range, e.g., 0.01 to 20 microns and of actual particle sizes in the range of No's. 100 to 400 sieves, preferably 140 to 325 sieves, U.S. Sieve Series. The bentonite and other such suitable swellable clays may be agglomerated to larger particle sizes too, such as 60 to 120 sieves, but such agglomerates are not preferred unless they include the organic fatty softener materials too (in any particulate products).

For purposes of providing a treated bentonite in accordance with the invention, the initial bentonite starting material is selected to have relatively low gelling and swelling properties. Specifically, the starting material bentonite is selected to have the following initial properties: (a) a montmorillonite content of at least 85%; and (b) when the bentonite is activated with sodium ions, dried and ground to particles, the ground particles do not swell more than about 2.5 fold over a period of 24 hours when added to deionized water at room temperature. The ground particles of bentonite for purposes of determining swelling herein are particles at least 90% of equal to or less than about 75 microns in diameter.

A detailed description of the process for treating bentonite in accordance with the present invention is disclosed in WO 00/03959 filed in the name of Colin Stewart Minchem, Ltd., the disclosure of which is incorporated herein by reference.

A main component which may be used in combination with the fabric softening clay is an organic fatty softener. The organic softener can be anionic, cationic or nonionic fatty chains (C₁₀-C₂₂ preferably C₁₂ -C₁₈) Anionic softeners include fatty acids soaps. Preferred organic softeners are nonionics such as fatty esters, ethoxylated fatty esters, fatty alcohols and polyols polymers. The organic softener is most preferably a higher fatty acid ester of a pentaerythritol compound, which term is used in this specification to describe higher fatty acid esters of pentaerythritol, higher fatty acid esters of pentaerythritol oligomers, higher fatty acid esters of lower alkylene oxide derivatives of pentaerythritol and higher fatty acid esters of lower alkylene oxide derivatives of pentaerythritol oligomers.

Pentaerythritol compound, abbreviated as PEC herein, which description and abbreviation may apply to any or all of pentaerythritol, oligomers, thereof and alkoxylated derivatives thereof, as such, or more preferably and more usually, as the esters, as may be indicated by the context.

The oligomers of pentaerythritol are preferably those of two to five pentaerythritol moieties, more preferably 2 or 3, with such moieties being joined together through etheric bonds. The lower alkylene oxide derivatives thereof are preferably of ethylene oxide or propylene oxide monomers, dimers or polymers, which terminate in hydroxyls and are joined to the pentaerythritol or oligomer of pentaerythritol through etheric linkages. Preferably there will be one to ten alkylene oxide moieties in each such alkylene oxide chain, more preferably 2 to 6, and there will be one to ten such groups on a PEC, depending on the oligomer. At least one of the PEC OH groups and preferably at least two, e.g., 1 or 2 to 4, are esterified by a higher fatty acid or other higher aliphatic acid, which can be of an odd number of carbon atoms.

The higher fatty acid esters of the pentaerythritol compounds are preferably partial esters. And more preferably there will be at least two free hydroxyls thereon after esterification (on the pentaerythritol, oligomer or alkoxyalkane groups). Frequently, the number of such free hydroxyls is two or about two but sometimes it may by one, as in pentaerythritol tristearate. The higher aliphatic or fatty acids that may be employed as esterifying acids are those of carbon atom contents in the range of 8 to 24, preferably 12 to 22 and more preferably 12 to 18, e.g., lauric, myristic, palmitic, oleic, stearic and behenic acids. Such may be mixtures of such fatty acids, obtained from natural sources, such as tallow or coconut oil, or from such natural air materials that have been hydrogenated. Synthetic acids of odd or even numbers of carbon atoms may also be employed. Of the fatty acids lauric and stearic acids are often preferred, and such preference may depend on the pentaerythritol compound being esterified.

Examples of suitable detergent compositions containing clay include those described in U.S. Pat. No. 6,291,421 and U.S. Pat. No. 6,670,320.

Other Optional Ingredients

Granulates according to any aspect of the present invention may also contain one or more other ingredients such as bleaches and/or bleach systems, enzymes, dyes, anti-dye transfer agents, dye fixatives, fluorescers, antifoams etc. These may be incorporated in the core, but optionally, may additionally or alternatively be introduced via the slurry to be incorporated in the core.

Thus, granulates according to the invention may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

Preferred bleach precursors are peroxycarboxylic acid precursors, more especially peracetic acid precursors and pernonanoic acid precursors. Especially preferred bleach precursors suitable for use in the present invention are N,N,N′,N′,-tetracetyl ethylenediamine (TAED) and sodium nonanoyloxybenzene sulphonate (SNOBS). The novel quaternary ammonium and phosphonium bleach precursors disclosed in U.S. Pat. No. 4,751,015 and U.S. Pat. No. 4,818,426 (Lever Brothers Company) and EP 402 971A (Unilever), and the cationic bleach precursors disclosed in EP 284 292A and EP 303 520A (Kao) are also of interest.

The bleach system can be either supplemented with or replaced by a peroxyacid. examples of such peracids can be found in U.S. Pat. No. 4,686,063 and U.S. Pat. No. 5,397,501 (Unilever). A preferred example is the imido peroxycarboxylic class of peracids described in EP A 325 288, EP A 349 940, DE 382 3172 and EP 325 289. A particularly preferred example is phthalimido peroxy caproic acid (PAP). Such peracids are suitably present at 0.1-12%, preferably 0.5-10%.

A bleach stabiliser (transition metal sequestrant) may also be present. Suitable bleach stabilisers include ethylenediamine tetra-acetate (EDTA), the polyphosphonates such as Dequest (Trade Mark) and non-phosphate stabilisers such as EDDS (ethylene diamine di-succinic acid). These bleach stabilisers are also useful for stain removal especially in products containing low levels of bleaching species or no bleaching species.

An especially preferred bleach system comprises a peroxy bleach compound (preferably sodium percarbonate optionally together with a bleach activator), and a transition metal bleach catalyst as described and claimed in EP 458 397A, EP 458 398A and EP 509 787A (Unilever).

The granulates according to the invention may also contain one or more enzyme(s). Suitable enzymes include the proteases, amylases, cellulases, oxidases, peroxidases and lipases usable for incorporation in detergent compositions. Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention. Examples of suitable proteolytic enzymes are the subtilisins which are obtained from particular strains of B. Subtilis B. licheniformis, such as the commercially available subtilisins Maxatase™, as supplied by Genencor International N.V., Delft, Holland, and Alcalase™, as supplied by Novozymes Industri A/S, Copenhagen, Denmark.

Particularly suitable is a protease obtained from a strain of Bacillus having maximum activity throughout the pH range of 8-12, being commercially available, e.g. from Novozymes Industri A/S under the registered trade-names Esperase™ and Savinase™. The preparation of these and analogous enzymes is described in GB 1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

The granulates of the invention may also contain alkali metal, preferably sodium carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Granules of the present invention suitably have a low bulk density in the range 400 to 900 g/l, or 500 to 800 g/l, for example, in the proximity of 650 g/l.

The composition may also comprise a post-dosed particulate filler which suitably comprises an inorganic salt, for example sodium sulphate and sodium chloride. The filler may be present at a level of 5 to 60% by weight of the composition.

A fully formulated detergent composition incorporating granules produced according to the invention might for example comprise the detergent active and builder and optionally one of more of a flow aid, a filler and other minor ingredients such as colour, perfume, fluorescer, bleaches and enzymes.

The invention will now be illustrated by the following non-limiting examples.

### EXAMPLES

A drum is fed with detergent powder having the formulation given in the Table below, onto which a slurry of perfume capsules is applied by spraying with a nozzle.

Spray system: Eminent E13 spray gun

Nozzle spec: 20 HTE nozzle.

Mixer: standard concrete mixer.

Mixing time: 15 minutes.

Batch size: 20 kg.

Spray-on rate: 0.8 kg hr⁻¹

Capsule concentration in slurry: 50 wt % (balance: water)

| Ingredient | Amount (wt %) |
|---|---|
| SodiumLAS | 11.1 |
| NI 7EO | 8.6 |
| Soap | 2.5 |
| Zeolite A24 | 26.4 |
| Sokalan CP5 | 2.1 |
| (Polyacrylate) | |
| SodiumCarbonate | 17.6 |
| NaSilicate | 2.0 |
| SCMC | 0.3 |
| NaSulphate | 22.3 |
| Moisture | 7.1 |
| Total | 100 |

Optionally, antifoam, bleach (TAED/percarbonate blend), and proteolytic+lipolytic enzymes are post-dosed.

1. A granulate detergent product comprising coated granules which comprise a functional core which comprises one or more detersive agents selected from surfactants, softening materials and detergency builders, the coated granules further comprising up to 10% by weight of a coating which comprises encapsulated perfume.

2. A granulate detergent product according to claim 1, wherein the coating comprises up to 5%, more preferably up to 2%, still more preferably up to 1%, by weight of the coating.

3. A granulate detergent product according to claim 1, wherein the coating further comprises unencapsulated perfume.

4. A granulate detergent product according to claim 1, wherein the encapsulated perfume comprises melamine-urea-formaldehyde microcapsules.

5. A granulate detergent product in which at least 10% of the total number of granules are coated granules which comprise a functional core which comprises one or more detersive agents selected from surfactants, softening materials and detergency builders, the coating comprising encapsulated perfume.

6. A particulate detergent composition comprising a granulate detergent product according to claim 1 in admixture with one or more other solid ingredients.

7. A particulate detergent composition comprising a granulate detergent product according to claim 1, from 0 wt % to 30 wt % of a linear alkylbenzene sulphonate surfactant and from 10 to 70% by weight of a detergency builder by weight of the total detergent composition.

8. A particulate detergent composition comprising a granulate detergent product according to claim 1 and from 10 to 95% by weight of softening material by weight of the total detergent composition.

9. A process for making a granulate detergent product, the process comprising:
(i) providing a powdered and/or granulated detersive composition comprising one or more detersive agents selected from surfactants, softening materials and detergency builders;
(ii) preparing a slurry comprising water and an encapsulated perfume;
(iii) spraying the detersive composition with said slurry to form coated granules.

10. A process according to claim 9, wherein the slurry further comprises unencapsulated perfume.

11. A process according to claim 9, wherein the slurry further comprises a viscosity modifier.

12. A process according to claim 9, wherein the slurry is sprayed onto the detersive composition in a low shear mixer or a moderate shear mixer.

13. A process of preparing a detergent composition, the process comprising preparing coated granules by a process according to claim 9 and admixing the coated granules with one or more other solid ingredients.

14. A process according to claim 9, wherein the coated granules are granules according to any of claims 1 to 5.

15. A process according to claim 9, wherein the coated granules are granules according to claim 6.
